(19) United States
(12) Patent Application Publication
(10) Pub. No.: US 2012/0204120 A1
(43) Pub. Date: Aug. 9, 2012

(54) SYSTEMS AND METHODS FOR CONDUCTING AND REPLAYING VIRTUAL MEETINGS

(76) Inventors: Marc P. Lefar, Atlanta, GA (US); Baruch Sterman, Efrat (IL); Nicholas P. Lazzaro, Atlanta, GA (US)

(21) Appl. No.: 13/022,802

(22) Filed: Feb. 8, 2011

(51) Int. Cl. G06F 3/048

(52) U.S. Cl. 715/757

(57) ABSTRACT

Systems and methods for conducting a virtual meeting cause a display screen to present meeting participants with a depiction of a virtual meeting room populated with avatars representing the participants. Audio links between the participants allow some or all of the participants to hear what is being said by each of the other participants. Each participant can cause his respective avatar to make gestures that provide non-verbal communications to the other participants. In addition, one or more participants may be able to cause text, images, videos or other presentation materials to be displayed to the other participants on a virtual display screen present in the virtual conference room. Likewise, participants may be able to draw or write on a virtual whiteboard present in the virtual conference room. Participants may also be able to share or send notes to each other, or conduct private instant messaging sessions, audio sessions or video sessions with one or more of the other participants. Actual movements made by participants could be sensed and interpreted by touch, video and inertial sensors. An interpretation of those movements could be used to change how the virtual meeting room appears, to animate the avatars, or to cause certain functions to be performed.

### BACKGROUND OF THE TECHNOLOGY

The technology is related to systems and methods that are used to conduct virtual meetings or conferences in a virtual meeting or conference room. Such virtual meetings and conferences can be held in place of an audio or video conference call.

When two or more individuals located at two or more locations wish to conduct a video conference call, a display screen, a microphone and a video camera are positioned at each location. The display screen at each location displays the images captured by the cameras positioned at the other locations, and all parties share a common audio stream.

If the video conference call involves individuals at three locations, it is necessary to provide a video screen presentation which is split, and where multiple windows are present on the screen, each window showing the participants at a different physical location. For example, if there are four locations participating in a video conference call, each location would have a display screen showing three windows, each window corresponding to the other three locations.

When an individual present at a first location participates in a video conference call, that individual must listen to whoever is speaking, and that person must also try to read non-verbal gestures, communications or clues generated by each of the other individuals present on the video conference call. And because some participants may be physically present in the room with the individual, and other participants will be viewable on three different windows on a display screen, it is very difficult to track the non-verbal communications from all participants simultaneously.

For example, one type of video conference call involves a distance learning session, where a teacher is conducting a class with students that are located in one or more locations separate from the teacher. In a normal classroom situation, it would be easy for the teacher to notice when a student raises his hand to ask the teacher a question. But when the learning session is being conducted as a video conference call, it may be impossible for a student to attract the teacher's attention using a non-verbal gesture such as raising one's hand. Instead, a student is usually forced to interrupt the teacher with a verbal request or question. This can be disruptive to the class session, and distracting for the teacher.

Likewise, in a business video conference call, it is often difficult for an individual who is making a presentation to accurately gauge the reactions of all of the participants because they are depicted on one or more windows of a display screen. The loss of this non-verbal feedback can be highly detrimental to the effectiveness of the presentation or the meeting. For example, because the individual making a presentation cannot read the facial expressions or body language of the other participants, the presenter may not realize that the participants are not understanding something and require a more detailed explanation.

### BRIEF DESCRIPTION OF THE DRAWINGS

FIG. 1 is a diagram illustrating a top view of a virtual meeting room with the avatars of four participants;

FIG. 2 is three dimensional view of a virtual meeting room with two participants;

FIGS. 3A-3C illustrate three alternative virtual meeting room designs;

FIG. 4 is a top view of a virtual meeting room with an overlay menu that allows a participant to select non-verbal gestures that can be made by the participant's avatar, and which illustrates that one avatar is nodding his head to indicate agreement;

FIG. 5 is a top view of a virtual meeting room with an overlay menu that allows a participant to select non-verbal gestures that can be made by the participant's avatar, and which illustrates that one avatar is shaking his head to indicate disagreement;

FIG. 6 is a top view of a virtual meeting room with an overlay menu that allows a participant to select non-verbal gestures that can be made by the participant's avatar, and which illustrates that one avatar is raising his hand to indicate he has a question;

FIG. 7 is a top view of a virtual meeting room with an overlay that illustrates how a participant could trace patterns on a touch screen or touch pad to cause certain actions to occur;

FIG. 8 is a top view of a virtual meeting room with an overlay menu that a participant can use to cause certain actions to occur, and where the option to play a video has been selected;

FIG. 9 is a top view of a virtual meeting room with an overlay menu that a participant can use to select a particular video for presentation during a virtual meeting, and where one video has been selected;

FIG. 10 is a view of a three dimensional view of a virtual meeting room that includes a virtual display screen that is playing a selected video;

FIG. 11 is a close-up view of the virtual display screen in the virtual meeting room depicted in FIG. 10 which illustrates the video being played on the virtual display screen;

FIG. 12 is a three dimensional view of a virtual meeting room that includes a virtual whiteboard with information displayed thereon;

FIG. 13 is a close-up view of the virtual whiteboard in the virtual meeting room depicted in FIG. 12;

FIG. 14 is an example of notes and an instant messaging session being conducted between two participants of a virtual meeting;

FIG. 15 illustrates elements of a system which allows multiple parties to participate in a virtual meeting; and

FIG. 16 is a diagram of elements of a virtual meeting system that is capable of conducting virtual meetings.

### DETAILED DESCRIPTION OF PREFERRED EMBODIMENTS

As noted above, when multiple parties to a video conference call are in different locations, it is difficult for a participant to see all of the non-verbal gestures being made by the participants. In contrast, when all members of a meeting are present in the same room at the same time, it is much easier to read non-verbal gestures. Particularly when everyone is seated at the same table.

The technology disclosed herein relates to systems and methods of conducting virtual meetings or conferences, as opposed to audio or video conference calls. During a virtual meeting, an image of a virtual meeting room is generated, and the participants are represented by avatars that are seated at a virtual table in the virtual meeting room. Each participant will be able to view an image of the virtual conference room, and the avatars seated at the virtual table.

Each participant is able to cause his/her own avatar to make non-verbal gestures which are seen by the other participants during the virtual meeting. For example, a participant could cause his avatar to shake his head to indicate disagreement, or nod his head to indicate agreement. Likewise, a participant could cause his avatar to raise his hand to indicate that the participant has a question. Participants could cause the avatars to make a great variety of non-verbal gestures to indicate of a range of non-verbal communications. And because each participant is able to see the movements and gestures of all of the participants, the information conveyed by those non-verbal gestures is not lost.

In some embodiments, the image of the virtual meeting room would be transmitted to the display screens of the participant's computers. In addition, an audio link would be provided so that all of the participants can hear what the other participants are saying, as is conventional in an audio or video conference call. One of the primary differences between a typical video conference call and a virtual meeting as described herein is that during a virtual meeting, the participants will be viewing images of a virtual meeting room, as opposed to video images of participants in different locations.

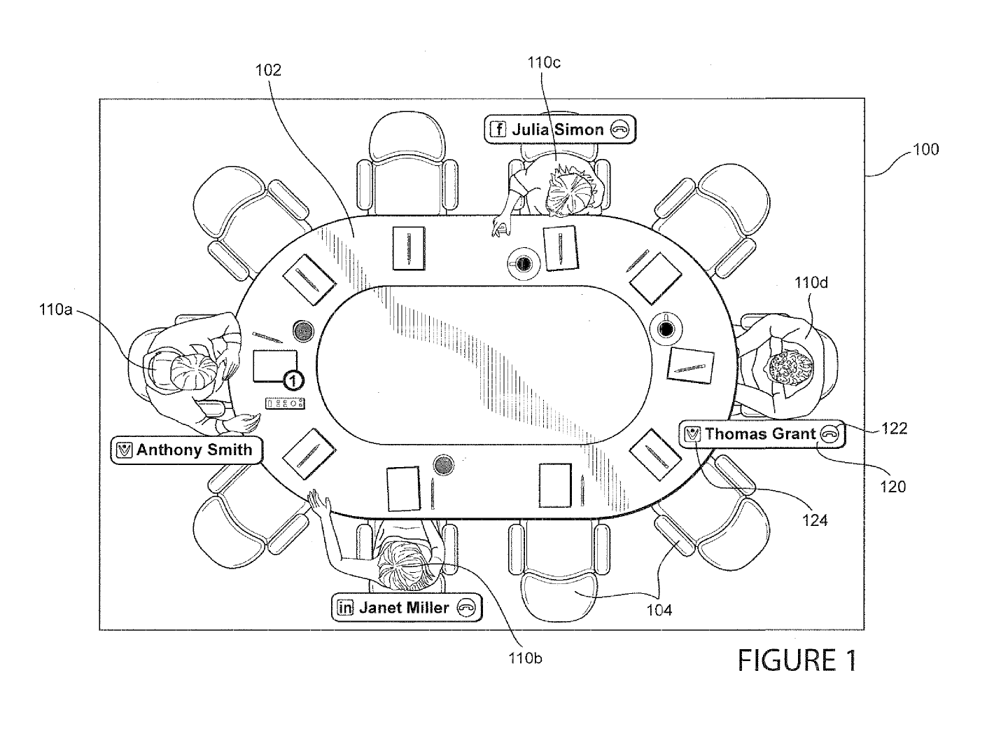

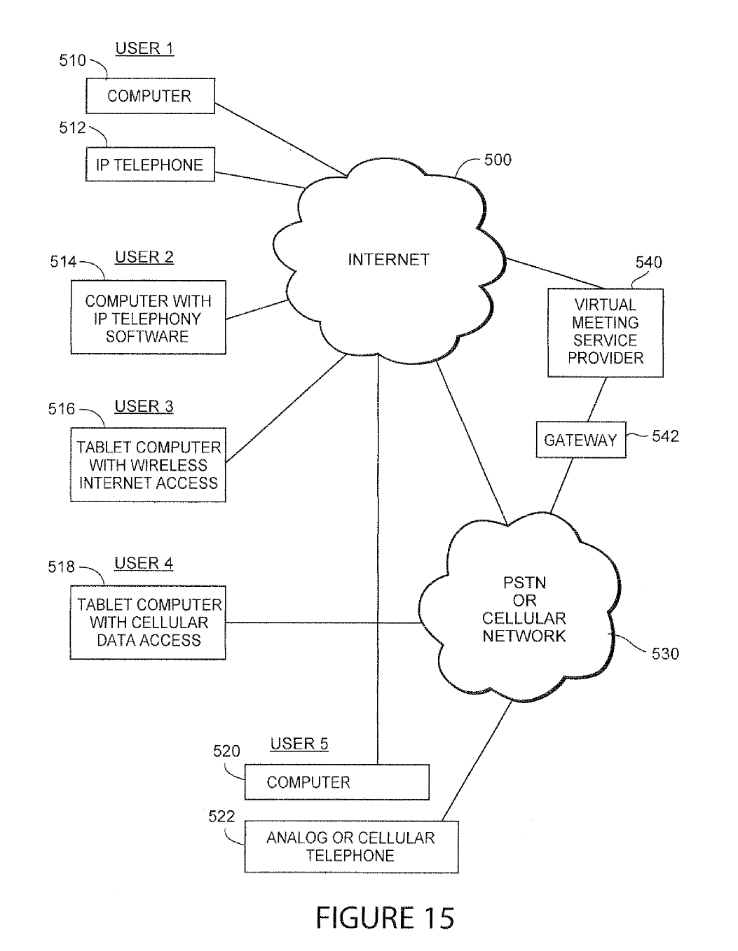

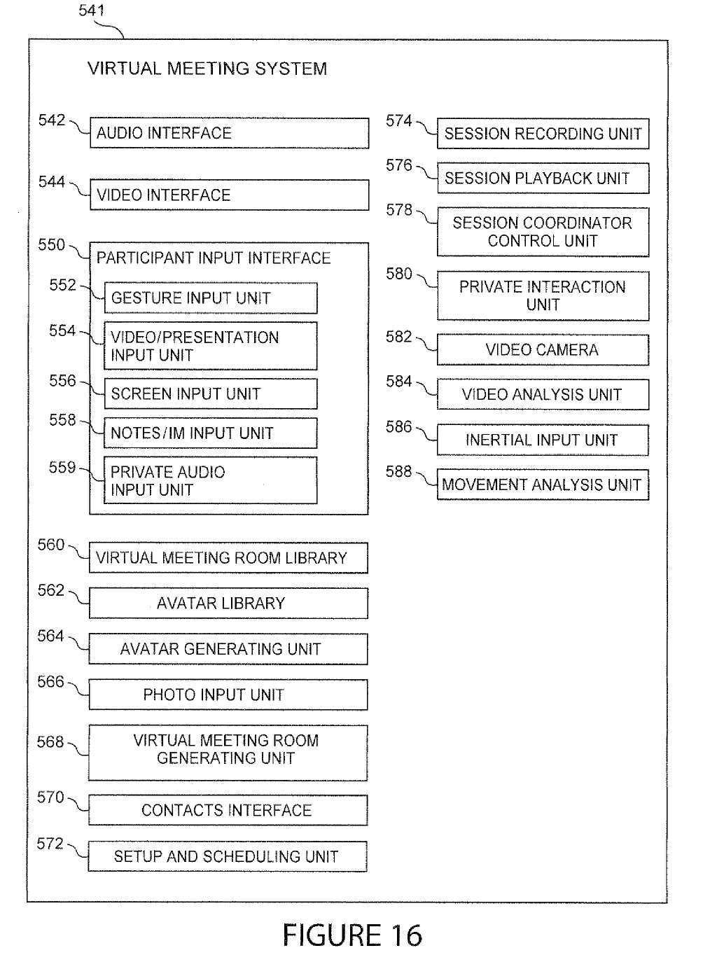

The basic concepts relating to what the participants would see and how the participants would interact with a system that provides virtual meeting services will first be described in conjunction with FIGS. 1-14. Thereafter, a description of a system capable of providing virtual meeting services will be described in conjunction with FIGS. 15 and 16.

FIG. 1 shows a top view of a virtual meeting room 100 having a virtual table 102. A plurality of avatars 110a, 110b, 110c and 100d are seated around the virtual table 102. Each avatar would correspond to a different virtual meeting participant. As illustrated in FIG. 1, name tags 120 may be provided in the image to indicate who corresponds to each avatar. As will be described in greater detail below, participants may be able to select icons 122, 124 on the name tags 120 to cause various actions to occur, such as initiating a private chat session or a private video conference with that person, or sending that person a private note.

In some embodiments, when a virtual meeting is being conducted an image as depicted in FIG. 1 would be transmitted to the display screens of one or more of the participants. As will be described in more detail below, the participants' computers and display screens may be linked to a system that provides virtual meeting services in various ways.

As noted above, when a virtual meeting is being conducted an audio link is also established with each participant. The audio links allow each participant to hear what the other participants are saying. The audio links might also provide the audio portions of audio or video recordings that are being played during a virtual meeting. As will be described in more detail below, the audio links can be established in a variety of different ways.

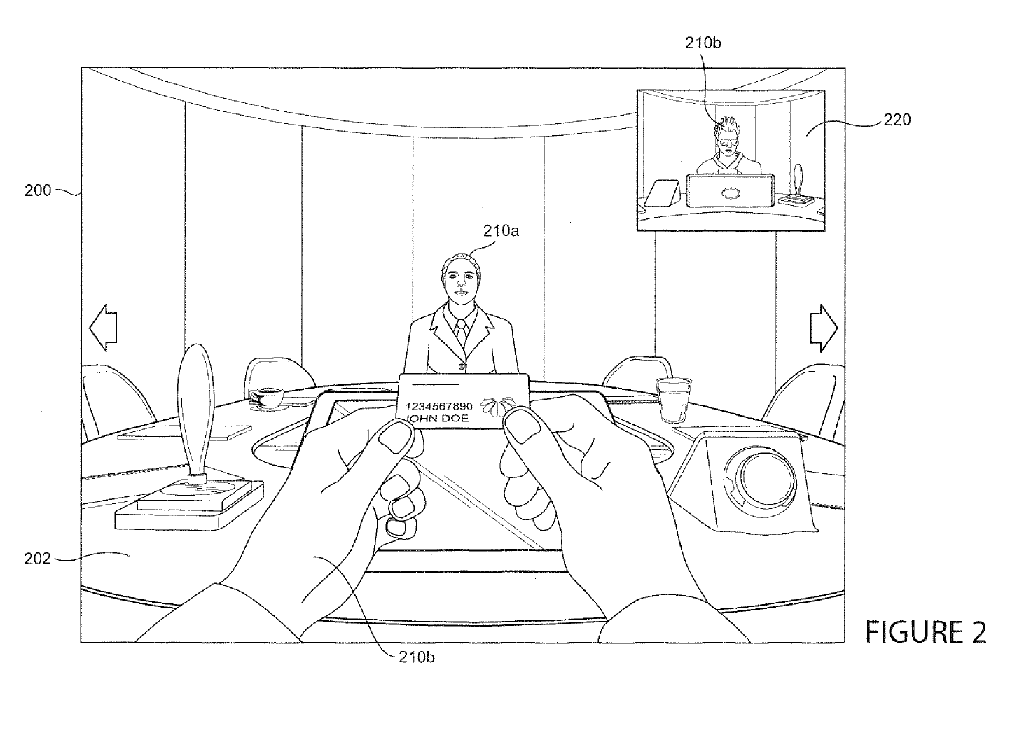

The image of a virtual meeting room illustrated in FIG. 1 is but one way to depict a virtual meeting room. For example, a virtual meeting room 200 could also be depicted in a three dimensional fashion, as illustrated in FIG. 2. With this type of three dimensional image, the virtual meeting room is shown as it would be seen through the eyes of an avatar 210b of a first participant. Thus, the image shows a frontal view of the avatar 210a of a second participant seated across the virtual table 202.

A three dimensional image of a virtual meeting room could also include a window 220 that shows how the avatar 210b of the first participant would look to one or more of the avatars or the other participants that are seated at the virtual table 202.

In some embodiments, each participant could select how he wishes to view the virtual meeting room. The system generating the images of the virtual meeting room would then generate an image of the room in accordance with the participant's wishes, and that image would be transmitted to the participant's display screen.

For instance, if all users choose to view the virtual meeting room in a top down view, as depicted in FIG. 1, the same image might be generated and transmitted to all of the participants' display screens. However, if one of the participants elected a three dimensional view, as illustrated in FIG. 2, the system providing the virtual meeting services would generate a view that corresponds to what the participant's avatar would see while sitting at the virtual table, and that image would be sent to the participant's display screen. All the other participants would receive the top down image.

If each of the participants choose to view a three dimensional image as depicted in FIG. 2, the system providing the virtual meeting services would need to generate a different image for each participant, where each image shows what the avatar for one of the participants would see. The different three dimensional views would then be transmitted to the participants' display screens.

In order to set up a virtual meeting, a meeting coordinator can select a date and time for the virtual meeting, as well as the participants that are to be invited. The selection of meeting participants could make use of electronic contact lists. For instance, the meeting coordinator could access an electronic contact list and make selections from that list to generate a list of virtual meeting participants. The contact list could include contact lists maintained by third parties, such as on social networking systems like Facebook, LinkedIn and MySpace.

The meeting coordinator could then electronically send a virtual meeting invitation to each of the selected participants using information contained on the contact lists, such as e-mail addresses or telephone numbers. The invitations could link to electronic calendars maintained by the selected participants. And those electronic calendars may allow the invited people to electronically respond to the virtual meeting invitation to confirm their attendance, or to indicate that they cannot participate in the meeting.

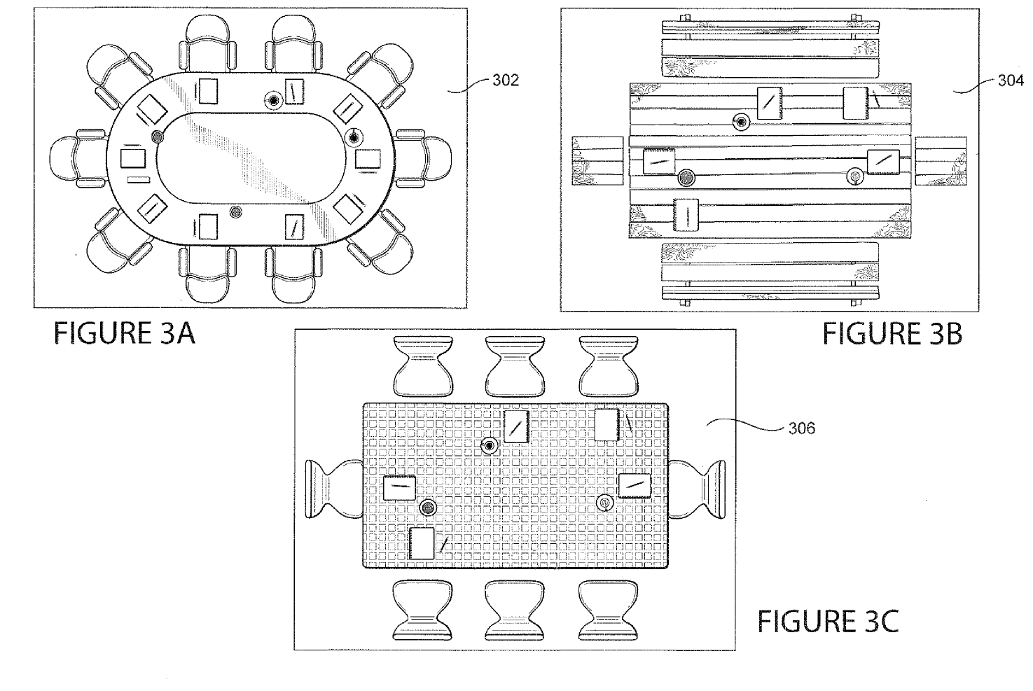

The virtual meeting coordinator may also be able to select the theme of the virtual meeting room. FIGS. 3A-3D illustrate different virtual meeting rooms and virtual meeting room tables that could be selected by the coordinator. The virtual meeting room 302 depicted in FIG. 3A provides a typical business setting. The virtual meeting room 304 in FIG. 3B provides a rustic table which may be more appropriate for a less formal virtual meeting. The virtual meeting room 306 depicted in FIG. 3C provides something in between. Thus, the coordinator can select a virtual meeting room that has a look that matches the anticipated mood or tenor of the virtual meeting.

The virtual meeting coordinator may also be able to customize the virtual meeting rooms in various ways. For example, a company logo could be added to the center of the meeting table, or it could be shown on a wall of the virtual meeting room. Likewise, the coordinator might be able to insert various artwork into the walls of a virtual meeting room. Also, virtual windows in a virtual meeting room could depict various scenes corresponding to real or artificially generated locations.

When the appointed time for the virtual meeting arrives, participants could join the virtual meeting in a variety of different ways. In some instances, the participants may be able to use a computer to navigate to a particular Internet address, at which they are allowed to join the virtual meeting. Digital data communications traversing the Internet between a participant's computer and a virtual meeting services system could provide both the audio and image portions of the virtual meeting.

In other instances, navigating to a particular Internet address may only establish a link providing the images of the virtual meeting room. The audio link might be established via a separate IP data link that utilizes a different audio interface than the participant's computer. Alternatively, an audio link may be established via a telephone connection, or via some other means.

The meeting coordinator may be able to trigger an outbound call or the establishment of a voice and/or data link to each of the meeting participants to cause the participants to join the meeting. This could include an action by the meeting coordinator to cause all meeting participants to join simultaneously, or the meeting coordinator could cause meeting participants to join individually. In still other instances, the meeting participants could take a positive action on their end to join the virtual meeting.

When a participant joins a virtual meeting, an avatar representing the participant may simply appear at the meeting table in the virtual meeting room. If that occurs, an announcement may be played to the other participants to let the other participants know who is joining the meeting. This announcement might be customizable by the participant, such as a predetermined sound or announcement associated with that participant.

In other instances, a participant may be temporarily placed in a virtual waiting room. The meeting coordinator could then be the person who ultimately admits the participant into the virtual meeting room. The participant may need to “knock” on a door to the virtual meeting room to request admittance into the virtual meeting room. Here again, the meeting coordinator or another participant could provide a signal that allows the participant to enter the virtual meeting room.

A participant may have pre-selected an avatar to represent them in the virtual conference room. If not, the participant may be presented with multiple different avatars that could be used to represent the participant in the virtual meeting room. The participant would then make a selection, and that avatar would appear at a place around the virtual table.

In some embodiments, a participant may be able to provide an image of their face, or a portion of their body. The image of the participant's face might then be superimposed onto the avatar representing the participant in the virtual meeting room. This would make it easier for the participants to recognize which avatar corresponds to each participant.

A participant may also be able to select a particular position at the virtual table, or the participants may be randomly assigned to seats. Also, the meeting coordinator may have predetermined the seating arrangements for the virtual table.

During a virtual meeting, the meeting coordinator may be able to control the ability of individual participants to interact with others on the call. For example, the meeting coordinator may be able to mute a participant, and/or block the participant from causing his avatar to make gestures, as described in more detail below. The meeting coordinator may also be able to establish a private conference between a selected few of the meeting participants. Those participants who have not been selected to participate in the private conference would effectively be put on hold while the private conference is conducted. They would be unable to hear what is being said by the participants in the private conference, and they may be unable to view the gestures made by the avatars of the participants in the private conference.

As explained above, one of the advantages to conducting a virtual meeting is that each participant can cause his avatar to make non-verbal gestures that are easily seen by the other participants. A participant could cause his avatar to make such non-verbal gestures in a variety of different ways.

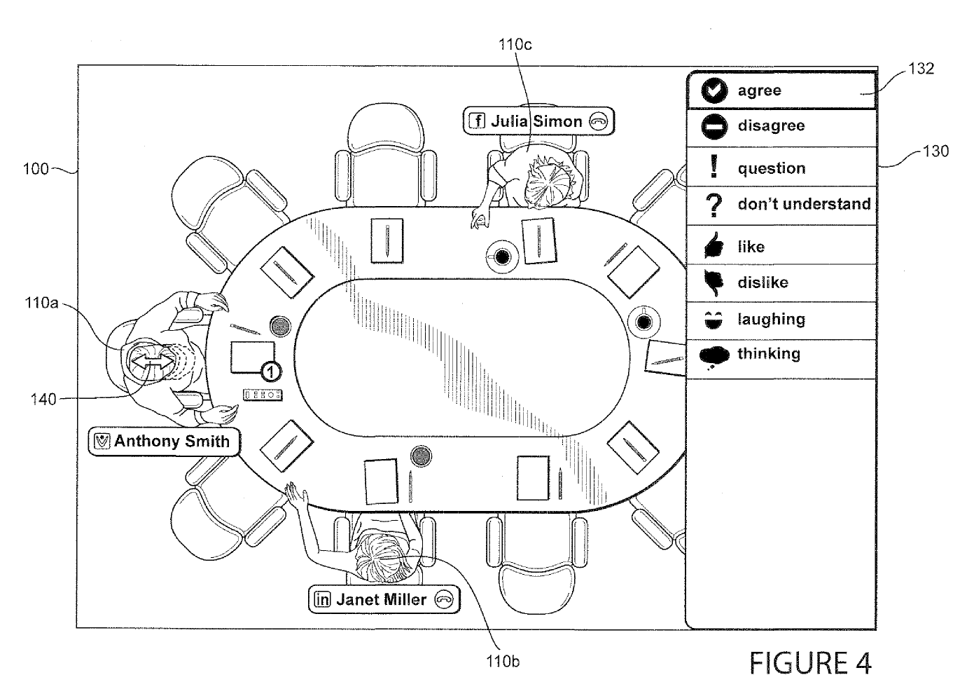

In some embodiments, a participant viewing the virtual meeting room on a computer display screen may be able to cause a gesture menu 130 to be presented on the display. The gesture menu could be presented to one side of the image of the virtual meeting room, or it could be overlaid on the image, as illustrated in FIG. 4. The participant would then select one of the gestures from the menu. In the image illustrated in FIG. 4, the participant has selected the menu option 132 corresponding to an agreement gesture.

The system providing the virtual meeting services would then cause the participant's avatar to move in accordance with the selected gesture. In the image illustrated in FIG. 4, the avatar 110a for the participant making the gesture selection would nod his head backward and forward, as indicated by the arrow 140, to indicate agreement. Alternatively, the avatar 110a could make a “thumbs-up” gesture, or perform both gestures simultaneously. The animated gesture would be continued for a predetermined period of time, and then it would stop.

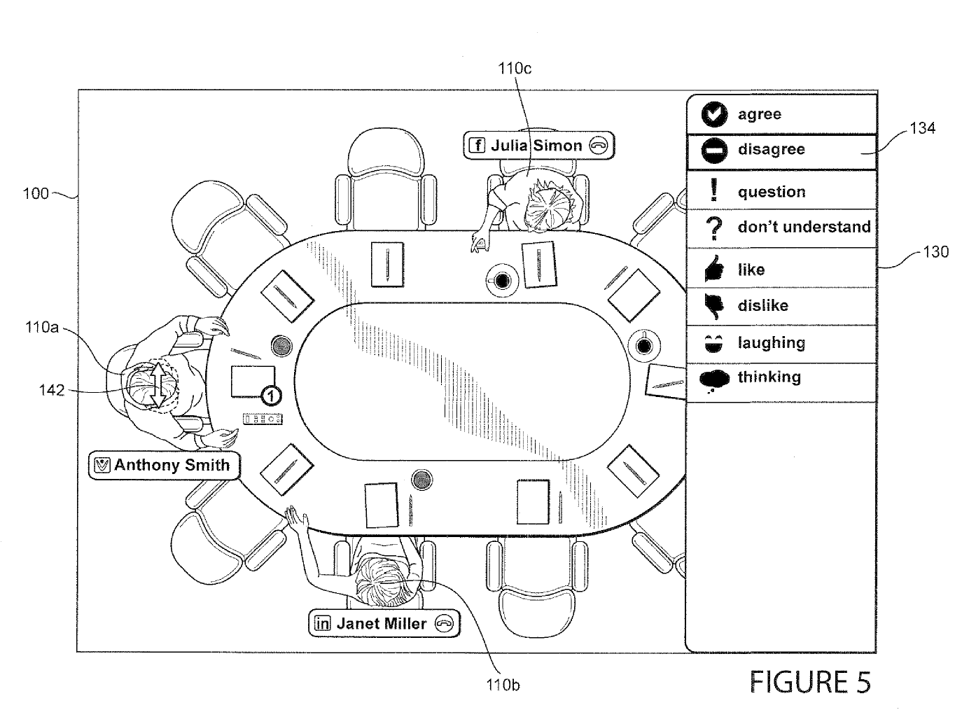

The image illustrated in FIG. 5 shows another example where the participant corresponding to avatar 110a has called up the gesture menu 130. In this example, the participant has selected the menu option 134 corresponding to the disagreement gesture. As a result, the system has caused the avatar 110a corresponding to the participant to shake his head back and forth, as indicated by the arrow 142. Alternatively, the avatar could wave a finger to indicate disapproval, or the avatar could perform both gestures simultaneously.

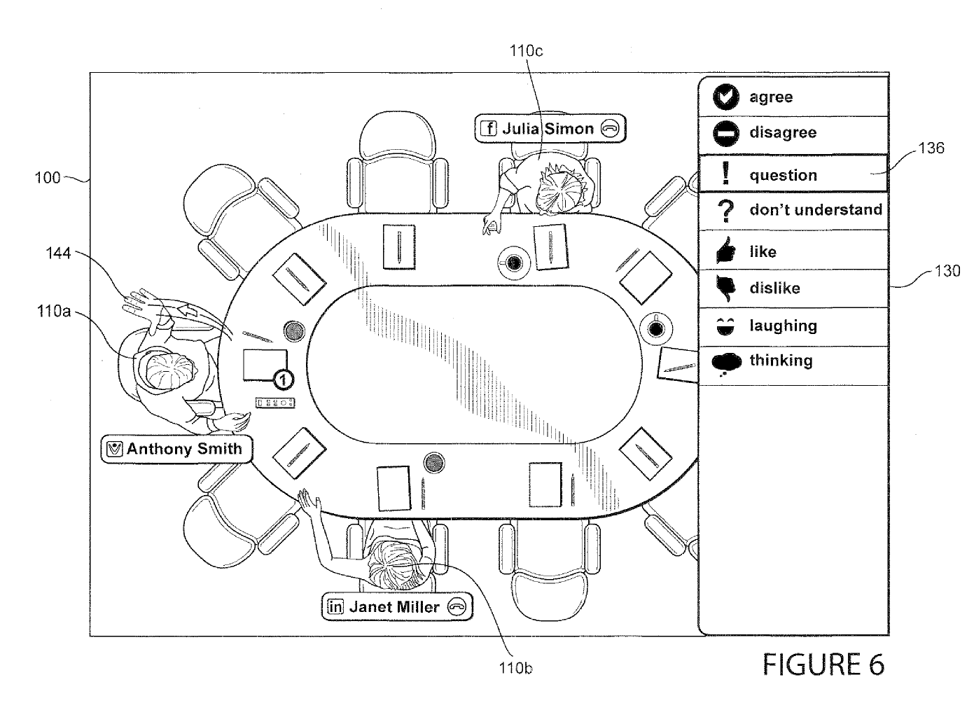

FIG. 6 illustrates another example where the participant corresponding to avatar 110a has called up the gesture menu 130. In this example, the participant has selected the menu option 136 corresponding to a question gesture. As a result, system has caused the avatar 110a corresponding to the participant to raise his hand 144, to indicate the participant has a question.

In another instance, a participant could select an option indicating that the participant has had an idea or thought. Once this option has been selected, the participant would have an opportunity to type a short text message explaining the thought. The system would then cause a balloon to appear over the participant's avatar, and the typed thought would be presented in the balloon.

In each of the examples described above, in order to cause his avatar to make a non-verbal gesture, the participant must (1) have a desire to make a non-verbal gesture; (2) call up a menu of available non-verbal gestures; (3) identify the desired non-verbal gesture on the menu; and (4) select the relevant option from the menu.

In an alternate embodiment, a participant's actual movements could be used to trigger his avatar to make a non-verbal gesture. The participant's movements would be sensed in some fashion, and an interpretation of the movements would be used to animate the participant's avatar.

In some embodiments, the participant could trace out a predetermined pattern on a touch sensitive device to cause his avatar to make a non-verbal gesture. In other instances, a video image of the participant could be captured and analyzed, and the data resulting from that analysis could cause the participant's avatar to make a particular non-verbal gesture. For example, if an analysis of a video image of the participant determines that the participant nodded his head in agreement, the participant's avatar could be animated to make a corresponding nodding movement to indicate agreement.

If a touch sensitive device is used, the touch sensitive device could be part of dedicated virtual conferencing equipment, or the touch sensitive device could part of a computer or portable computing device.

As explained above, an image of the virtual meeting room would be displayed on display screen for each participant. The display screen could be part of a typical desktop or laptop computer. Most desktop computers make use of a mouse or another similar device which can provide pointing, selecting and dragging capabilities. Also, many laptop computers make use of a touchpad that provides pointing, dragging and selecting capabilities. The pointing device of a desktop computer and/or the touchpad of a laptop computer could be utilized by a participant to trace out patterns corresponding to gestures to be performed by the participant's avatar. Similarly, a participant could trace out a predetermined pattern to provide function selection instructions to cause various functions to be performed.

Alternatively, a participant's display screen could be a touch sensitive display screen. For instance, a participant could be utilizing a computing device having a large touch sensitive display screen, such as a tablet device like the iPad™ or a wireless telephony device such as the iPhone™, both manufactured and sold by Apple, Inc. of Cupertino, Calif. Here again, the touch sensitive display screen could be utilized by a participant to trace out predetermined patterns corresponding to non-verbal gesture instructions, as well as function selection instructions.

If a meeting participant is using a computing device or a portable computing device that includes one or more inertial sensors, it might be possible for a participant to move the computing device in a predetermined fashion to cause his corresponding avatar to make a gesture. For example, moving the computing device up and down could cause the avatar to perform a gesture indicating agreement, and moving the computing device from side to side could cause the avatar to perform a gesture indicating disapproval.

If the touch sensitive device is part of a computer or a portable computing device, the device could establish a link to the system providing the virtual meeting services via the Internet, via a cellular data or telephone link, or possibly via a telephone link through the PSTN. This would allow the device to inform the virtual meeting service provider whenever a meeting participant traces out a particular predetermined pattern on the touch sensitive device to cause his avatar to make a non-verbal gesture or to request that a function be performed.

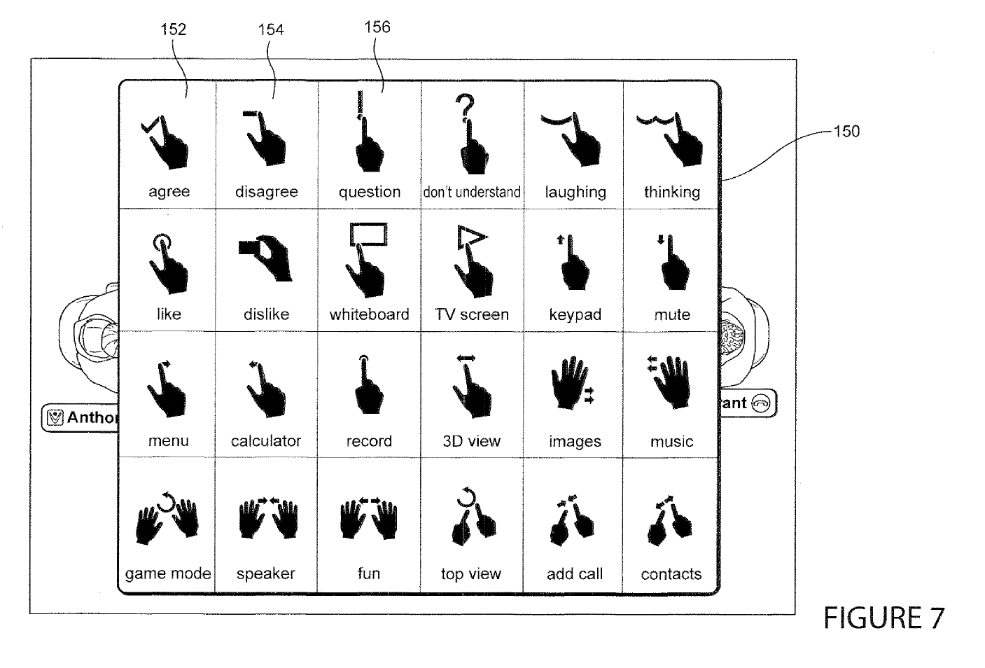

FIG. 7 depicts an overlay 150 that a participant could cause to appear on a display of a virtual meeting room. The overlay illustrates the different patterns that a participant could trace out on either a touch sensitive display, or on a touchpad to cause various actions to occur.

For instance, as illustrated in pane 152 of the overlay 150, a participant could trace out a checkmark to instruct the virtual meeting services system to cause the participant's avatar to make a non-verbal agreement gesture, such as nodding the avatar's head. Similarly, tracing out a straight line from left to right, as illustrated in pane 154, could cause the participant's avatar to make a disagreement non-verbal gesture, such as shaking the avatar's head. Tracing out an exclamation point, as illustrated in pane 156, could cause the participant's avatar to make a questioning non-verbal gesture, such as raising the avatar's hand. Other non-verbal gestures are considered within the scope of the invention that include but are not limited to those depicted in the overlay 150 of FIG. 7.

The ability to recognize and respond to a user tracing out particular patterns on a touch sensitive display or a touchpad may be enabled at all times during a virtual meeting. Alternatively, a user may be able to turn this ability on and off. One anticipates that participants will gradually learn each of the predetermined patterns over time, at which point the overlay will not be necessary. But until a participant has learned the patterns and what they represent, the participant may be able to call up the overlay for instruction.

As noted above, tracing out a particular pattern could activate functions other than causing an avatar to make a particular non-verbal gesture. As illustrated in the overlay depicted in FIG. 7, tracing out particular predetermined patterns could cause the image presented to the participant to switch between a top down view as illustrated in FIG. 1 and a three dimensional view as illustrated in FIG. 2. Tracing out other patterns could cause the virtual meeting services system to perform various other functions which are considered within the scope of the invention and which include but are not limited to those depicted in the overlay 150 of FIG. 7.

The image of the virtual meeting room can include a virtual display screen that is used to present text, images, presentation materials and video to participants of a virtual meeting. The meeting coordinator or the individual participants could control the display of such items on the virtual display screen.

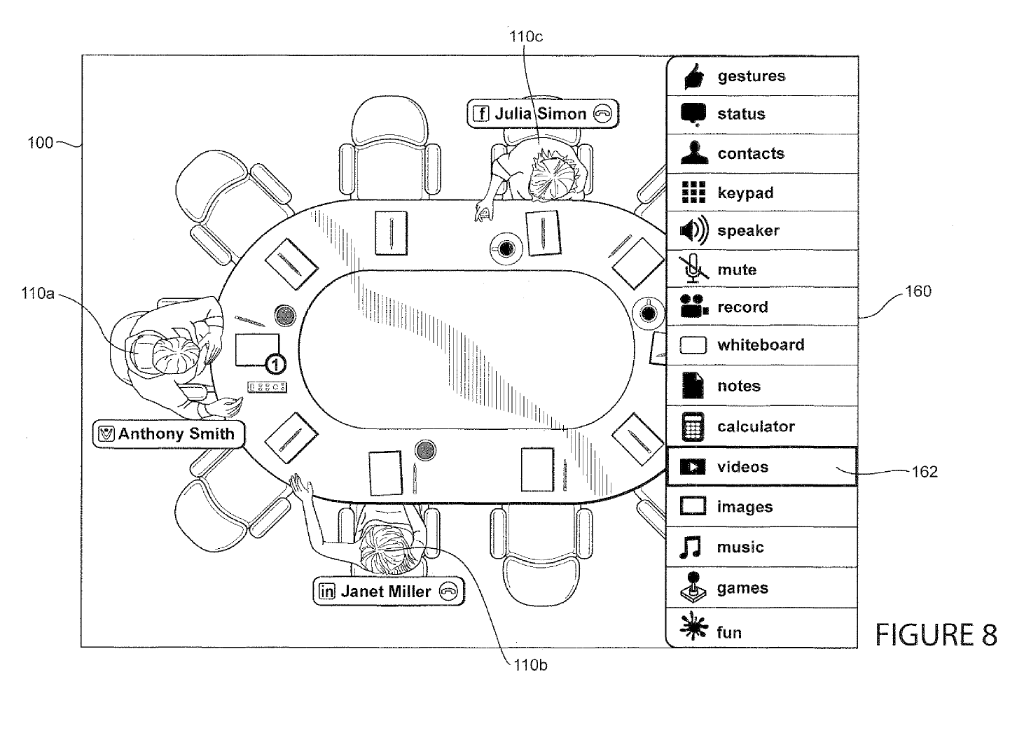

For example, the image depicted in FIG. 8 shows that the meeting coordinator or a participant has activated an overlay menu 160 listing various functions. In this image, the video presentation button 162 has been selected.

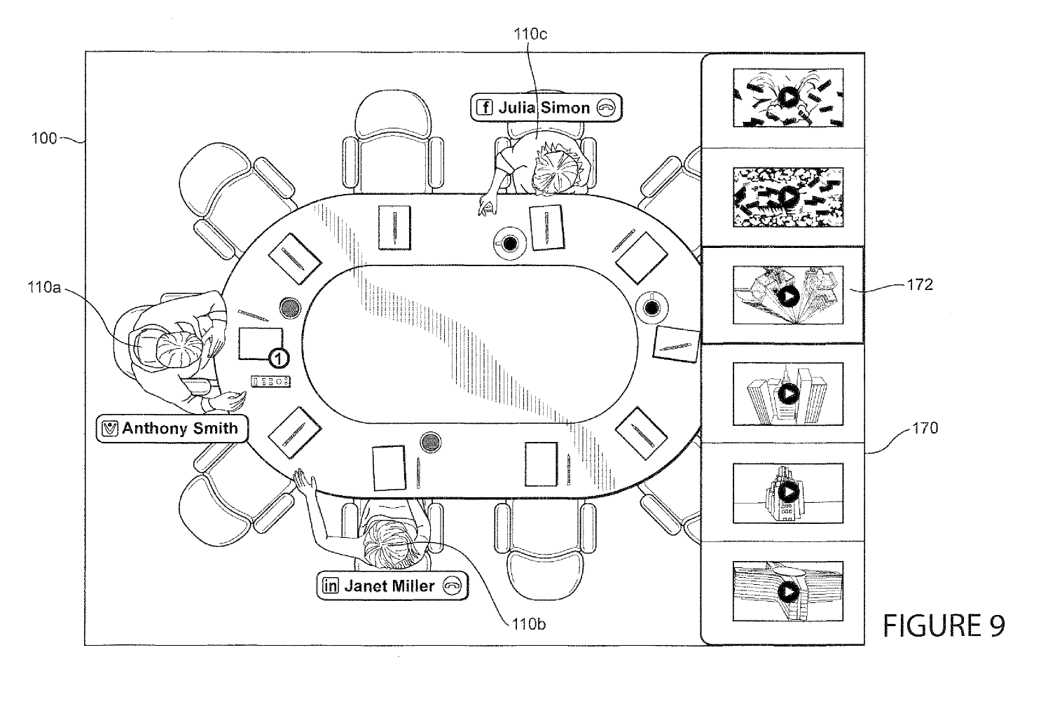

The next image that the coordinator or participant would see is depicted in FIG. 9. In this image, a menu 170 of different available video presentations is displayed. These video presentations could be preloaded onto the virtual meeting services system, or the video presentations could be resident on the coordinator or participant's computer. In this image, the coordinator or participant has selected one of the video presentations 172 to be displayed on a virtual display screen in the virtual meeting room.

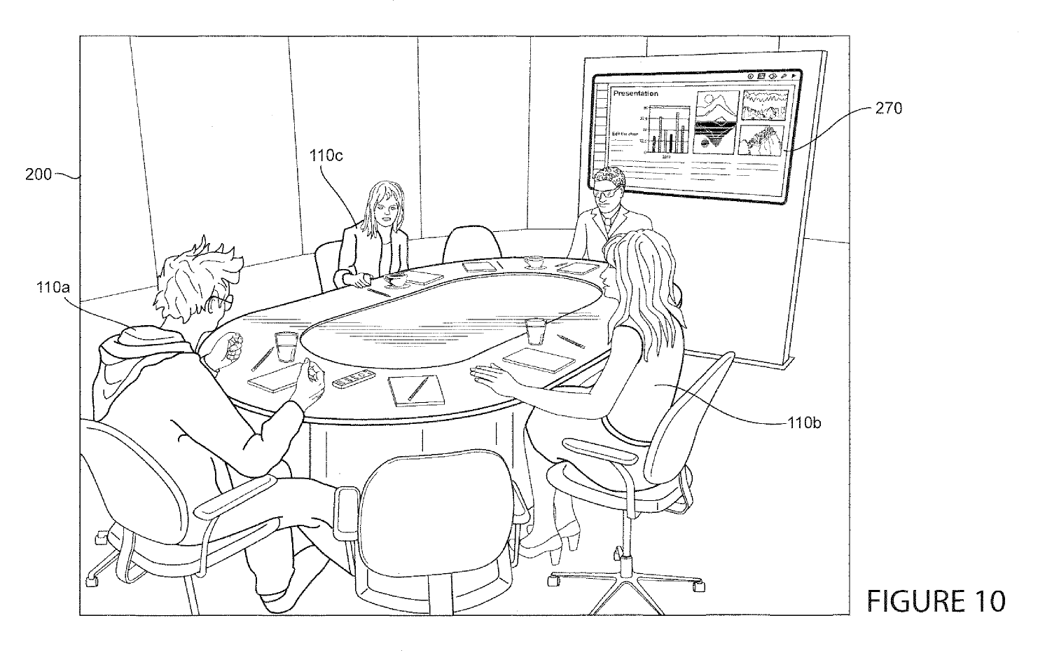

FIG. 10 illustrates a three dimensional view 200 that could be shown to all the meeting participants when a video presentation begins. In this image, a virtual display screen 270 located in the virtual meeting room is displaying the video presentation selected by the coordinator or participant using the menu depicted in FIG. 9. In some instances, the video presentation on the virtual display screen 270 will appear in sufficient detail in the view presented in FIG. 10 for the participants to clearly see the video presentation. In which case, the participants could continue to view the image depicted in FIG. 10 while the video presentation is played. This would also allow the participants to continue to monitor any non-verbal gestures made by the meeting participants.

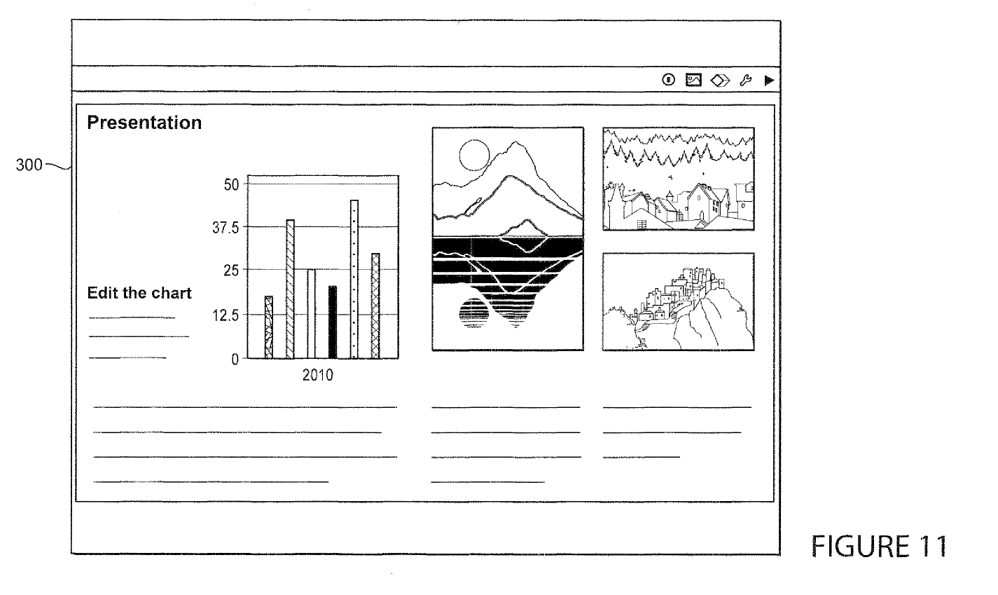

If the virtual display screen 270 does not depict the video presentation in sufficient detail, one or more of the participants could request a more detailed view of the virtual display screen 270, as depicted in the image appearing in FIG. 11. Although the virtual display screen 300 now fills the participant's entire screen, the participant could continue to hear the audio of all the participant's spoken comments. And the participant could switch back to a view as provided in FIG. 10, or views as depicted in FIG. 1 or 2 at any time.

Although the above description involved selecting and playing a video presentation on a virtual display screen using menus, the selection and playing of a video presentation might also be accomplished by tracing out patterns on a touch sensitive display screen or a touchpad, as explained above.

In addition, although the foregoing description involved selecting and playing a video presentation, a similar method could be used to select and display text, images or mixed media presentations such as those created by the PowerPoint® presentation application, developed and sold by Microsoft Corporation of Redmond, Wash. Here again, the selected material would be displayed on a virtual display screen in the virtual meeting room.

In still other embodiments, it may be possible for a meeting coordinator or a participant to cause what the person sees on his own computer display screen to be displayed on a virtual display screen of the virtual meeting room. For instance, this would allow a coordinator or participant to conduct a live Internet search during the virtual meeting, and allow all participants to view the search.

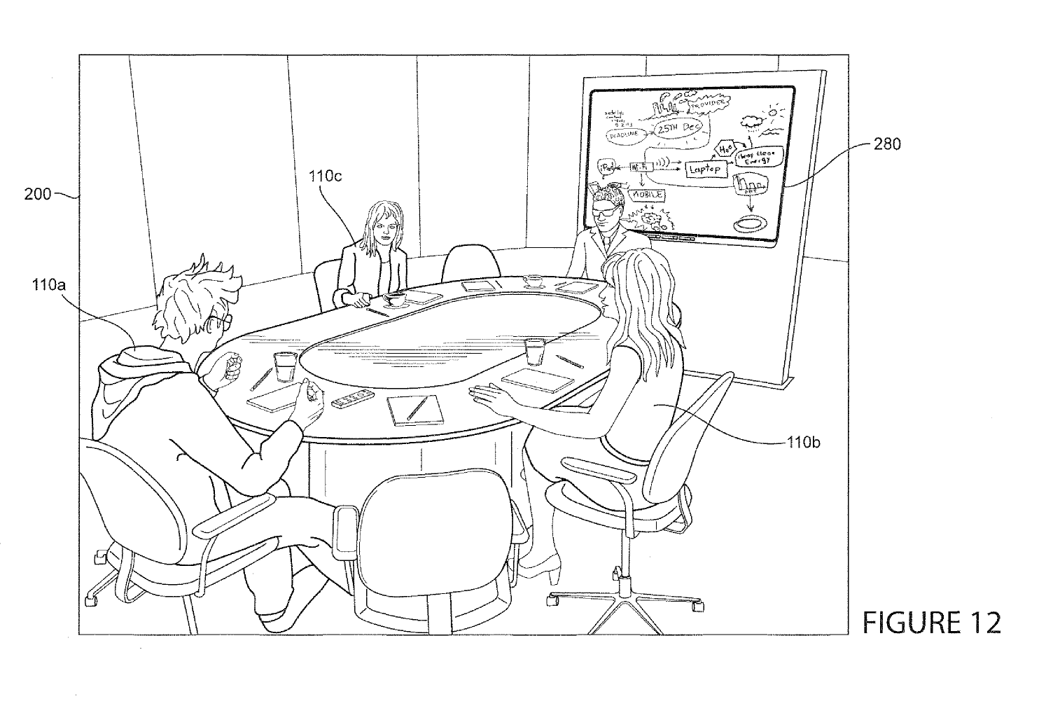

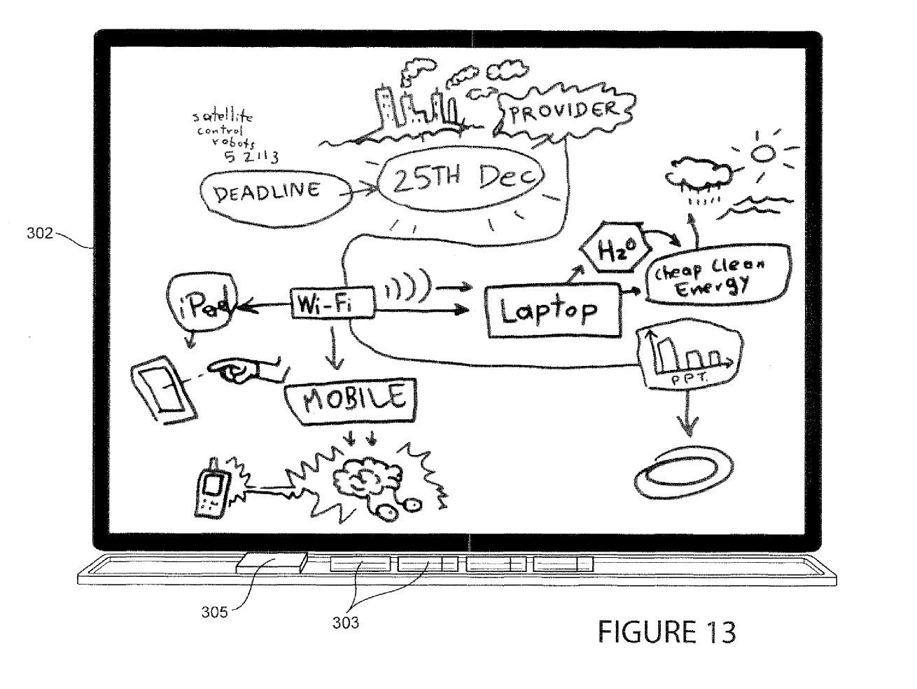

A virtual display screen in the virtual meeting room might also be used as a whiteboard 280, as illustrated in FIG. 12. Here again, when the whiteboard feature is activated, the participants may be presented with a three dimensional view, as depicted in FIG. 12, which would allow the participants to continue to see and monitor any non-verbal gestures made by the other participants. Alternatively, a participant may choose to switch to a view as depicted in FIG. 13, where the whiteboard 302 fills the entire display. This would still allow the participant to continue to monitor the audio of the virtual meeting.

When the whiteboard feature has been activated, one or more participants may be able to write on the virtual whiteboard. Creating marks on the whiteboard could be done by tracing patterns on a touch sensitive display. In some instances, only one participant at a time will have the ability to mark on the whiteboard. The meeting coordinator may determine who has this ability, or the participant presently in control of the whiteboard might pass control over to the next participant.

Each participant may be able to mark on the whiteboard in a different color. Alternatively, a single participant might be able to select different colors to illustrate different items. For instance, if an image as illustrated in FIG. 13 is being presented on a touch sensitive display, a participant could switch between colors by touching one of the marker pens 303 at the bottom of the virtual whiteboard, and then tracing out a pattern on the touch sensitive display. Likewise, a participant might be able to touch the eraser 305, and then trace a pattern on his touch sensitive display to erase marks on the whiteboard.

In some embodiments, multiple participants might be able to simultaneously mark on the whiteboard, and each participant would mark a different color.

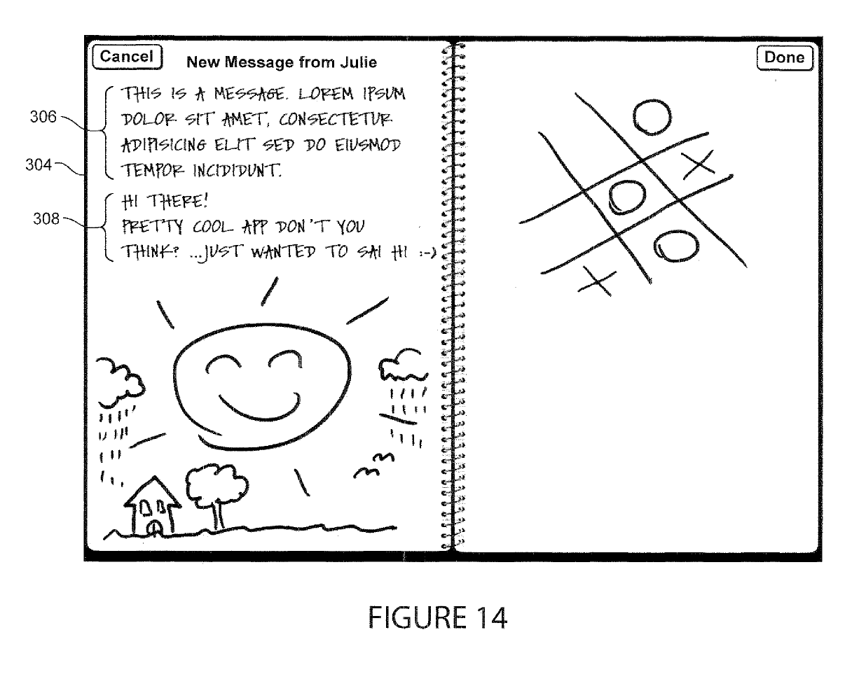

Participants in a virtual meeting may be able to generate notes which can be shared with all or selected ones of the participants. FIG. 14 illustrates notes that a participant could have created using a keyboard, or a touch sensitive display, or both. When a participant so chooses, this image could be displayed to all the participants on the virtual display screen in the virtual meeting room, or as a full screen display.

Participants in a virtual meeting might also be able to send private notes between each other during a virtual meeting. This could be conducted like a typical instant messaging session. In the image displayed in FIG. 14, a first participant has written a first text message 306 which appears in a first color, and a second participant has written a second text message 308, which appears in a second color. The image illustrated in FIG. 14 might be seen only by the first and second participants, so that the communication remains private. Of course, a first participant could also conduct such a private conversation with two or more participants as well.

As an alternative to a private text messaging session, two or more participants could also establish a private audio conference between themselves while a virtual meeting is being conducted. In some instances, the audio from the virtual meeting might be played at a lower volume while the private audio session is conducted. Also, anything spoken by the participants in the private audio session would only be sent to the other participants in the private audio session. In other instances, the audio from the virtual meeting might be muted while the private audio session is conducted.

In a similar fashion, if two participants on a virtual meeting both have computers or portable computing devices with video capabilities, the participants could conduct a private video chat session during a virtual meeting. In this instance, a window might be opened on the display screen depicting the virtual meeting room, and the video images from each participant to the private video session would appear in the window.

In some embodiments, a virtual meeting coordinator may have the ability to selectively empower certain participants to contribute to the audio portion of a virtual meeting. Also, individual participants would have the ability to mute their microphones during a virtual meeting, similar to a typical audio and/or video conference call.

The system providing virtual meeting services could record each virtual meeting. Such recordings could be made available to the participants and others for playback. If text, images, videos or notes were displayed on a virtual display screen in the virtual meeting room during a virtual meeting, recordings of those presentations might be separately available.

In some embodiments, a meeting participant or the meeting coordinator may be able to cause non-participants to view and listen in on a virtual meeting as it is being conducted. The non-participants could see the virtual meeting room and the avatars on a display screen, and also hear the audio portion of the meeting, but the non-participants would not have the ability to contribute to the virtual meeting, and they would not have an avatar present in the virtual meeting room. A non-participant could be presented with a view of the meeting room as seen from one of the avatars at the virtual meeting room table, or the non-participant could be presented with a view of all the avatars, as from a side of the virtual meeting room.

While the virtual meeting functions described above are ideal for allowing business people to conduct virtual meetings in place of audio or video conference calls, the same capabilities could be used to conduct educational classes. The teacher or instructor and the students of such class could be located at multiple different locations.

The ability to easily display images, text and video presentations on a virtual display screen, and the ability for the teacher and the students to both access and use a virtual whiteboard during such a virtual class would be ideal in an educational environment. In addition, because such virtual classes can be easily recorded and replayed, students would be able to review previously occurring classes to study a subject. Also, students that were unable to participate in a live virtual class would still be able to view a recording of the virtual class.

The ability to access not only the teacher's audio presentation, but also diverse presentation materials that were displayed during a virtual class make recording a teacher's classes extremely simple, compared to current distance learning systems where a camera must attempt to obtain video images of all these things during the live class.

FIG. 15 illustrates how user computers, displays and audio devices can link to a virtual meeting services provider so that the users can participate in virtual meetings. As illustrated in FIG. 15, the virtual meeting services provider 540 would be linked to the Internet 500. The virtual meeting services provider 540 might also be linked to a publically switched telephone network (PSTN) and/or a cellular telephone network 530 via a gateway 542.

A first user could have a computer 510 and an Internet Protocol (IP) telephone 512 that are both linked to the Internet 500. Digital data traversing the Internet 500 would link the first user's computer 510 and IP telephone 512 to the virtual meeting services provider 540.

When a virtual meeting is being conducted, the first user's computer 510 could provide a display screen to display an image of the virtual meeting room. The computer might also provide an audio interface that allows the first user to send audio data to the virtual meeting services provider 540, and to hear what is being spoken by the other participants. In other instances, the display screen of the first user's computer could display the image of the virtual meeting room, and the first user's IP telephone 512 could provide the audio link to the virtual meeting.

A second user has a computer running IP telephony software 514. The second user's computer could establish both the audio and video links to the virtual meeting without resort to the IP telephony software on the computer 514. Alternatively, the computer could provide the video link, and the IP telephony software could establish the audio link.

A third user has a tablet computer 516, such as an Apple iPad™, which has wireless access to the Internet. The tablet computer 516 would establish the video and audio links to the virtual meeting via digital data passing over the Internet 500. In addition, the display of such a device could both present the image of the virtual meeting room, and act as a touch sensitive input device to allow a user to instruct the virtual meeting services provider to take various actions, as explained above.

A fourth user has a tablet computer 518, such as an Apple iPad™, which utilizes the cellular network 530 to establish a data link to the Internet 500. The tablet computer could establish the video and audio links to the virtual meeting via digital data passing over the Internet 500, as routed through the cellular data link. Alternatively, a video link could be established through the Internet 500, and an audio link could be established via a separate audio channel that passes through the cellular network 530, the gateway 542 and on to the virtual meeting services provider 540. As noted above, the display of such a device could both present the image of the virtual meeting room, and act as a touch sensitive input device to allow a user to instruct the virtual meeting services provider to take various actions.

A fifth user has a computer 520 connected to the Internet. The computer would be utilized to establish a video link to a virtual meeting. The fifth user also has an analog or cellular telephone 522 which is used to establish an audio link to the virtual meeting services provider via the PSTN/cellular network 530 and the gateway 542.

A virtual meeting system 541 for providing virtual meeting services is illustrated in FIG. 16. The system 541 is part of the operational infrastructure of the virtual meeting services provider 540 and can be either a single unit comprised of a plurality of subcomponents or a plurality of discrete components interconnected by one or more public and/or private networks such as, but not limited to the Internet 500, PSTN or cellular network 530 or the like. The system 541 includes an audio interface 542 which sends the audio portion of a virtual meeting to various participants, and which also receives audio input from the participants. The audio interface may perform selected noise cancelation to prevent audio input from a first participant from being fed back to the first participant, to thereby prevent undesirable feedback loops. Also, as described above, the audio interface is capable establishing an audio link to various participants in multiple different ways. The audio interface can send audio to a participant via the Internet, or via a PSTN or cellular network.

The system 541 also includes a video interface 544 which sends images of a virtual meeting to participants. As noted above, each participant in a virtual meeting may receive a different image of a virtual meeting room. Also, participants may ask to receive different views of a virtual meeting room at different times during a virtual meeting. The video interface is responsible for determining which image to generate and send to each participant, and for timely delivery of such images.

The system 541 further includes a participant input interface 550. The participant input interface includes a gesture input unit 552 for receiving instructions from participants about how their respective avatars should be animated to display non-verbal gestures. Additionally, the system 541 comprises a plurality of input units to facilitate greater interaction of the virtual meeting as described in greater detail earlier. For example, a video/presentation input unit 554 receives presentation materials that are to be presented on a virtual display screen in a virtual meeting room. A screen input unit 556 receives screen data from a participant's computer screen when a participant wishes to slave the virtual display screen in a virtual meeting room to his own computer display so that others can see what is displayed on the participant's computer. A notes/IM input unit 558 receives notes and instant messages from a participant. The notes might be presented to all participants, or only to selected participants in a private session. Likewise, instant messages would only be sent to selected participants. Finally, a private audio input unit allows two or more participants to conduct a private audio session, as explained above.

The gesture input unit 552 could receive input from individual participants in multiple formats. As explained above, participants may be able to call up a gesture menu and select a particular gesture that they would like their avatar to perform. In this instance, the gesture input unit 552 would receive information about the selection made by the participant.

In other instances, a participant could trace out a predetermined pattern on a touch sensitive input unit to request that his avatar perform a particular gesture. In this instance, the gesture input unit 552 could receive information about the particular pattern traced by the participant. Alternatively, the device upon which the participant traced out the predetermined pattern might interpret the traced pattern and send the gesture input unit an indication of what gesture the participant has requested.

Further, as explained above, menu selections and tracing predetermined patterns on a touch sensitive input unit could be performed to request that the virtual meeting services system perform a certain function, instead of causing an avatar to make a particular gesture. In these instances, the gesture input unit 552 would receive information about the menu selection or the traced pattern, and the gesture input unit 552 would use this input to cause a particular requested function to be performed.

In still other embodiments, participants could request that their avatars perform certain gestures or that functions be performed by making a physical gesture that is detected by one or more video cameras. For example, if a participant is using a computer or portable computing device which includes a video camera, the video camera could be focused on the participant during all or a part of a virtual meeting. When the participant makes a non-verbal gesture, such as shaking his head to indicate disagreement, this movement would be detected by the video camera. The virtual meeting services system would interpret the gesture, and it would then cause the participant's avatar to perform the same gesture.

In some embodiments, the virtual meeting system 541 may itself include one or more video cameras 582 that are positioned in one or more actual meeting rooms where participants gather when a virtual meeting is being conducted. The video camera(s) 582 would capture body gestures made by the participants, and the captured video images would be analyzed by a video analysis unit 584 to determine if a participant has made a gesture indicative of a non-verbal communication, or a request for a particular function to be performed. For example, if the video analysis unit 584 determines that a video image of a participant captured by a video camera 582 shows the participant raising his hand to indicate he has a question, the virtual meeting system 541 would then cause that participant's avatar to raise his hand.

If a participant is using a computer or a portable computing device to link to the virtual meeting system 541, and the computer or portable computing device is capturing a video image of the participant, the video image may also be analyzed by the video analysis unit 584 of the virtual meeting system 541. Alternatively, software on the computer or portable computing device may analyze the video image to determine when the participant has made a non-verbal gesture that should be echoed by his avatar, or a gesture requesting that a particular function be performed. This information would then be communicated to the virtual meeting system 541.

In still other embodiments, participants could utilize an inertial input unit 586 to provide input to the virtual meeting system 541 for various purposes. The inertial input unit could be a handheld controller that includes one or more accelerometers, gyroscopes or other inertial sensors that detect the relative position or movements of the handheld controller. Such a handheld controller could be grasped by a participant and moved to cause various actions to occur.

For example, a participant could grasp the handheld controller and raise his hand to indicate that he has a question. The signals output from the inertial sensors would indicate the movement performed by the participant. And this information would be interpreted by a movement analysis unit 588 as the participant raising his hand. The virtual meeting system 541 would then cause the participant's avatar to also raise his hand.

Such a handheld controller could be user for other input purposes. For example, if a participant wished to point to particular places on a virtual display screen being shown in a virtual meeting room, the handheld controller could be operated by a participant like a laser pointer, to cause a highlighted dot or arrow to appear on the virtual display screen. Movements of the handheld controller would then cause the highlighted dot or arrow to move in corresponding directions across the virtual display screen.

The inertial input unit 586 could utilize a three axis accelerometer or a three axis gyroscopic unit to detect movements. In addition, an imaging unit in the inertial input unit could also be used to detect movements of the inertial input unit 586. Outputs from both an imaging unit and one or more inertial sensors could be used together to determined the relative orientation and movements of such an input unit.

In some embodiments, the inertial input unit 586 may be part of the equipment provided by the virtual meeting system 541. In other embodiments, the participants themselves might provide an inertial input unit, and data produced by the inertial input unit would be transmitted to the movement analysis unit 588 for analysis.

In still other embodiments, an inertial input unit provided by a participant might be capable of analyzing the data output by the inertial sensors and/or imaging unit of the inertial input unit. In which case, the data transmitted to the virtual meeting system 541 might just indicate the gestures or movements performed by a participant. In yet other embodiments, the data produced by sensors of an inertial input unit could be analyzed by a participant's computer or portable computing device, and data regarding a gesture or movement performed by the participant would be sent to the virtual meeting system 541.

The system 541 includes a virtual meeting room library 560, which has images of multiple different virtual meeting rooms that can be selected for individual virtual meetings.

An avatar library 562 provides different avatars that can appear in virtual meetings. Custom tailored avatars corresponding to individual participants could be stored here, in addition to stock or standard avatar forms. For instance, participant avatars with photos of the participants could be stored in the avatar library 562. A photo input unit 566 could also allow participants to upload images of themselves, or of anything else. An avatar generating unit 564 is capable of creating custom avatars for participants using information from the avatar library 562 and the photo input unit 566.

A virtual meeting room generating unit 568 generates the images of a virtual meeting room that are transmitted to participants by the video interface 544. This can include melding together information from the virtual meeting room library 560 and the avatar library 562 and/or avatar generating unit 564. This can also include producing multiple different views of the same virtual meeting room for each of the participants in a virtual meeting.

The system 541 may also include a contact interface 570 which allows a meeting coordinator to select meeting participants from contact lists. The contact interface may communicate with third party systems to obtain data from contact lists stored by those third party systems.

The system 541 also includes a setup and scheduling unit 572 that can be used by a meeting coordinator to setup a virtual meeting, send out electronic invitations, and coordinate the implementation of the virtual meeting.

In one embodiment of the invention, the setup and scheduling unit 572 is an integral part of the virtual meeting system 541. In an alternate embodiment of the invention, the setup and scheduling unit 572 is an interface that ties into third party calendaring and scheduling applications. Accordingly, the meeting coordination tasks are handled by the third party application and relevant information about a meeting (participant list, date, time, location, materials and the like) is relayed to the system 541 via the interface. A representative third party application is the Outlook® information manager developed and sold by Microsoft® Corporation of Redmond, Wash.

A session recording unit 574 is responsible for recording each virtual meeting, including any presentation materials and any whiteboarding actions that occur during the virtual meeting. A session playback unit 576 allows participants and other authorized users to review a virtual meeting that has been recorded, as well as the presentation materials that were displayed.

A session coordinator and control unit 578 controls the actions that occur during a virtual meeting. Typically, this would involve taking direction from a meeting coordinator to control who can speak during a virtual meeting, who can present materials on a virtual display screen, and who can mark on a virtual whiteboard.

A private interaction unit 580 allows participants in a virtual meeting to set up private instant messaging sessions, private audio sessions, and possibly private video chat sessions.

While the technology has been described in connection with what is presently considered to be the most practical and preferred embodiments, it is to be understood that the technology is not to be limited to the disclosed embodiments, but on the contrary, is intended to cover various modifications and equivalent arrangements included within the spirit and scope of the appended claims.

1. A system for conducting a virtual meeting, comprising:
a virtual meeting room generation unit that generates an image of a virtual meeting room and which transmits the image of the virtual meeting room to display screens of a plurality of meeting participants, wherein the image of the virtual meeting room includes avatars representing at least some of the participants; and
a gesture input unit that receives gesture instructions regarding how a participant's avatar should be animated to communicate non-verbally, wherein the gesture instructions are the result of an interpretation of a movement made by the participant.

2. The system of claim 1, wherein the virtual meeting room generation unit generates images of the virtual meeting room in which the avatars are animated in accordance with the received gesture instructions.

3. The system of claim 1, wherein the gesture instructions comprise data indicative of how the participant moved one or more digits of a hand across a touch sensitive display screen or a touch pad of a computer.

4. The system of claim 3, wherein when the gesture instructions indicate that the participant moved one or more digits of the participant's hand across a touch sensitive display screen or a touch pad of a computer in a predetermined pattern, and wherein the virtual meeting room generation unit generates images of the virtual meeting room in which the participant's avatar is animated in a fashion that corresponds to the predetermined pattern.

5. The system of claim 1, further comprising a video analysis unit that analyzes a video image of the participant to interpret a movement made by the participant and that generates the gesture instructions that are provided to the gesture input unit based on that analysis.

6. The system of claim 5, wherein when the video analysis unit determines that the participant has made a predetermined non-verbal gesture, the gesture instructions result in the participant's avatar being animated to reproduce that predetermined non-verbal gesture.

7. The system of claim 5, wherein when the video analysis unit determines that the participant has made a non-verbal gesture indicative of a predetermined concept, the gesture instructions result in the participant's avatar being animated to convey the predetermined concept.

8. The system of claim 1, wherein the gesture input unit also receives function instructions indicative of a function that a participant would like to have performed, and wherein the function instructions are the result of an interpretation of a movement made by the participant.

9. The system of claim 8, wherein the function instructions comprise data indicative of how the participant moved one or more digits of at least one hand across a touch sensitive display screen or a touch pad of a computer.

10. The system of claim 8, further comprising a video analysis unit that analyzes a video image of the participant to interpret a movement made by the participant and that generates the function instructions that are provided to the gesture input unit based on that analysis.

11. The system of claim 8, wherein if the function instructions indicate that the participant has requested a function be performed, the virtual meeting room generation unit generates an image of a virtual meeting room that includes the performance of that function.

12. The system of claim 1, further comprising an inertial input unit that receives input data from at least one inertial sensor indicative of a movement performed by a participant, and wherein the virtual meeting room generation unit generates an image of a virtual meeting room that is based on the input data received from the at least one inertial sensor.

13. A system for conducting a virtual meeting, comprising:
means for generating an image of a virtual meeting room which includes avatars representing at least some of the participants;
means for transmitting the image of the virtual meeting room to display screens of a plurality of meeting participants; and
means for receiving gesture instructions regarding how a participant's avatar should be animated to communicate non-verbally, wherein the gesture instructions are the result of an interpretation of a movement made by the participant.

14. A method of conducting a virtual meeting, comprising:
generating an image of a virtual meeting room which includes avatars representing at least some of the participants;
transmitting the image of the virtual meeting room to display screens of a plurality of meeting participants; and
receiving gesture instructions regarding how a participant's avatar should be animated to communicate non-verbally, wherein the gesture instructions are the result of an interpretation of a movement made by the participant.

15. The method of claim 14, wherein the generating step comprises generating images of the virtual meeting room in which the avatars are animated in accordance with the received gesture instructions.

16. The method of claim 14, wherein the gesture instructions comprise data indicative of how the participant moved one or more digits of a hand across a touch sensitive display screen or a touch pad of a computer.

17. The method of claim 16, wherein when the gesture instructions indicate that the participant moved one or more digits of the participant's hand across a touch sensitive display screen or a touch pad of a computer in a predetermined pattern, the generating step comprises generating images of the virtual meeting room in which the participant's avatar is animated in a fashion that corresponds to the predetermined pattern.

18. The method of claim 14, further comprising:
analyzing a video image of the participant to interpret a movement made by the participant; and
generating the gesture instructions based on that analysis.

19. The method of claim 18, wherein if the analyzing step results in a determination that the participant has made a predetermined non-verbal gesture, the generating step includes the generating images of the virtual meeting room in which the participant's avatar is animated to reproduce that predetermined non-verbal gesture.

20. The method of claim 18, wherein if the analyzing steps results in a determination that the participant has made a non-verbal gesture indicative of a predetermined concept, the generating step comprises generating images of the virtual meeting room in which the participant's avatar is animated to convey the predetermined concept.

21. The method of claim 14, further comprising receiving function instructions indicative of a function that a participant would like to have performed, wherein the function instructions are the result of an interpretation of a movement made by the participant.

22. The method of claim 21, wherein if the function instructions indicate that the participant has requested a function be performed, the generating step comprises generating images of the virtual meeting room in which the function is performed.

23. The method of claim 14, further comprising receiving input data from at least one inertial sensor indicative of a movement performed by a participant, and wherein the generating step comprises generating an image of a virtual meeting room that is based on the input data received from the at least one inertial sensor.
